(19) United States
(12) Patent Application Publication
(10) Pub. No.: US 2006/0134436 A1
(43) Pub. Date: Jun. 22, 2006

(54) Air oxidizable scratch resistant protective layer for optical coatings

(75) Inventor: Peter Alan Maschwitz, Sebastopol, CA (US)

Correspondence Address: ROTHWELL, FIGG, ERNST & MANBECK, P.C., 1425 K STREET, N.W., SUITE 800, WASHINGTON, DC, 20005, US

(73) Assignee: AFG Industries, Inc., Kingsport, TN (US)

(21) Appl. No.: 11/303,992

(22) Filed: Dec. 19, 2005

Related U.S. Application Data
(60) Provisional application No. 60/636,656, filed on Dec. 17, 2004.

(51) Int. Cl. B05D 5/06

(52) U.S. Cl. 428/426; 428/432; 428/446; 428/701; 428/702; 428/698; 427/162

(57) ABSTRACT

The present invention provides a scratch protecting layer comprising a metal, metal alloy, metal compound or an intermetallic layer deposited on an air contacting surface. The scratch protecting layer is typically from 1 to 3 nanometers thick and not optically absorbing after oxidation occurs. This layer is initially deposited in a primarily unoxidized or un-nitrided state. Full oxidation of the metal, metal alloy, metal compound or intermetallic layer occurs within several days after exposure to air. The scratch protection layer can be 2 to 5 nanometers thick if the layer is exposed to a plasma, electrical discharge or ion beam comprising a reactive gas such as oxygen or nitrogen.

This application claims the benefit of U.S. Provisional 60/636,656 filed Dec. 17, 2004.

### FIELD OF THE INVENTION

The present invention relates, generally, to outer scratch protective layers which are fully oxidizable without exposure to heat. The outer protective layers are applied on top of optical coatings on various substrates and provide enhanced scratch protection for the layers underneath. In particular, the present invention relates to the use of a metal, metal compound or intermetallic layer as an outer scratch protective layer of an optical coating.

### DESCRIPTION OF RELATED ART

Low emissivity optical coatings or optical coatings containing infrared reflecting metals, can be deposited on transparent substrates to reduce the transmission of some or all of the infra-red radiation incident on the substrates. Anti-reflected thin silver coatings have been found to reflect a high proportion of infra-red radiation but allow visible light to pass through. These desirable properties have lead to the use of anti-reflected silver coated substrates in various applications such as window glass where the coating improves the thermal insulation of the window. Low emissivity silver coatings are described in U.S. Pat. Nos. 4,749,397 and 4,995,895. Vacuum deposited low emissivity coatings containing silver are presently sold in the fenestration marketplace.

U.S. Pat. No. 4,995,895 teaches the use of oxidizable metals as haze reduction topcoats useful for protecting temperable low-e coatings. This patent is directed to methods of reducing haze resulting from exposure to temperatures over 600° C.

Metal, metal alloy and metal oxide coatings have been applied to low emissivity silver coatings to improve the properties of the coated object. U.S. Pat. No. 4,995,895 describes a metal or metal alloy layer which is deposited as the outermost layer of the total layers applied to a glass base. The metal or metal alloy layer is oxidized and acts as an anti-reflection coating. U.S. Pat. No. 4,749,397 describes a method where a metal oxide layer is deposited as an antireflection layer. Sandwiching the silver layer between anti-reflection layers optimizes light transmission.

Unfortunately, optical coatings are frequently damaged during shipping and handling by scratching. Metal thin film layers are well known to be vulnerable to scratch damage. Thin film stacks consisting of dielectrics or combinations of metal and dielectric layers also frequently suffer from scratching. This vulnerability to scratching is particularly true of sputtered low-emissivity (also known as “soft” low-e) coatings on architectural glass. The substrates for low-e coatings may be as large as 3 by 4 meters yet still must be moved by robotic or human means. Thus, damage by mechanical abrasion frequently occurs. In view of this, most low emissivity stacks in use today make use of barrier layers somewhere in or on the low emissivity thin film stack. Some reduce damage from physical scratching of the low emissivity stack by virtue of their hardness or by lowering friction if they form the outer layer.

Pure metals are currently used as oxidizable corrosion and scratch resistant layers. Metal layers are known to be effective barriers due to their ability to physically and chemically inhibit diffusion. If the layer is non-porous, diffusion is physically blocked.

Sputtered carbon protective layers have been utilized to provide scratch protection but sputtered carbon is typically optically absorbing in the visible wavelengths and is removed by oxidation at temperatures above 400° C. The carbon scratch resistant layer would no longer be effective after a low emissivity coating undergoes heating due to tempering of the glass substrate.

Oxidizable metal nitrides have been used as protective scratch resistant layers and are also optically absorbing except in the cases of silicon and aluminum nitrides. Optically absorbing metal nitrides oxidize only at high temperatures.

It is common practice to make the outermost layer of a low-e coating from a hard material. Silicon nitride is one hard material often used for the outermost dielectric layer in low-e coatings. Scratch resistance of low-e stacks having silicon nitride as the outer layer is generally improved over stacks having tin oxide or zinc oxide as outer dielectrics as taught in patent application US 2003/0235719 A1. Silicon nitride also has the advantage of being heat resistant and is used in temperable low-e coatings.

Thin films of silicon nitride may depart from stoichiometric Si₃N₄. The thin film material used for the outer dielectric of a low-e stack may consist of silicon oxy-nitride. The stoichiometry of the layer may vary from sub-stoichiometric to super-stoichiometric with respect to the degree of reaction with nitrogen or oxygen. In order to make silicon conductive and suitable for sputtering, aluminum may also be a constituent as a dopant to silicon and is typically in a 1 to 10 weight ratio with the silicon, although the aluminum ratio may be higher. Other dopants such as boron may also be used. Numerous other types of thin film optical stacks may benefit from this scratch protection including but not limited to metallic reflective coatings, optical stacks with top layers other than silicon oxy-nitride or most other optical interference type designs.

Scratches in a low emissivity optical coating may not become visible until after the coating is heated and tempered, which can cause the scratches to grow and propagate.

Thus, there exists a need in the art for a protective layer that fully oxidizes at room temperature and has sufficient hardness and durability to reduce damage from scratching while allowing the transmission of visible light.

It is a purpose of different embodiments of this invention to fulfill the above described needs in the art, and/or other needs which will become apparent to the skilled artisan once given the following disclosure.

### SUMMARY OF INVENTION

The primary object of the present invention is to overcome the deficiencies of the prior art described above by providing an air oxidizable protection layer with sufficient hardness and durability to reduce damage from scratching while allowing the transmission of visible light.

Another object of the present invention is to produce a protection layer that substantially reduces scratching without significantly affecting optical properties such as transmission or reflection. The protection layer must also be easy to apply with minimal disruption to the optical coating process and should not require exposure to heat.

The present invention achieves all of the above discussed objectives by using a metal, metal alloy, metal compound or an intermetallic layer on an air contacting surface at a thickness not greater than that which will fully oxidize in air at room temperature. The scratch protecting layer is typically from 1 to 3 nanometers thick and not optically absorbing after oxidation occurs. This layer is initially deposited in a primarily unoxidized or un-nitrided state. Full oxidation of the metal, metal compound or intermetallic layer occurs within several days after exposure to air. The scratch protection layer can be 2 to 5 nanometers thick if the layer is exposed to a plasma, electrical discharge or ion beam comprising a reactive gas such as oxygen or nitrogen.

Further features and advantages of the present invention, as well as the structure and composition of preferred embodiments of the present invention are described in detail below with reference to the accompanying drawings.

### BRIEF DESCRIPTION OF THE DRAWINGS

The preferred embodiments of this invention will be described in detail with reference to the following figures. These figures are intended to illustrate various embodiments of the present invention and are not intended to limit the invention in any manner.

FIG. 1 shows an example of a low-e structure with an air oxidizable metal topcoat.

FIG. 2 shows the Delta haze results from the scratch testing.

FIG. 3 shows changes in transmission over time for a low-e structure with a Zr topcoat between 1-3 nm thick.

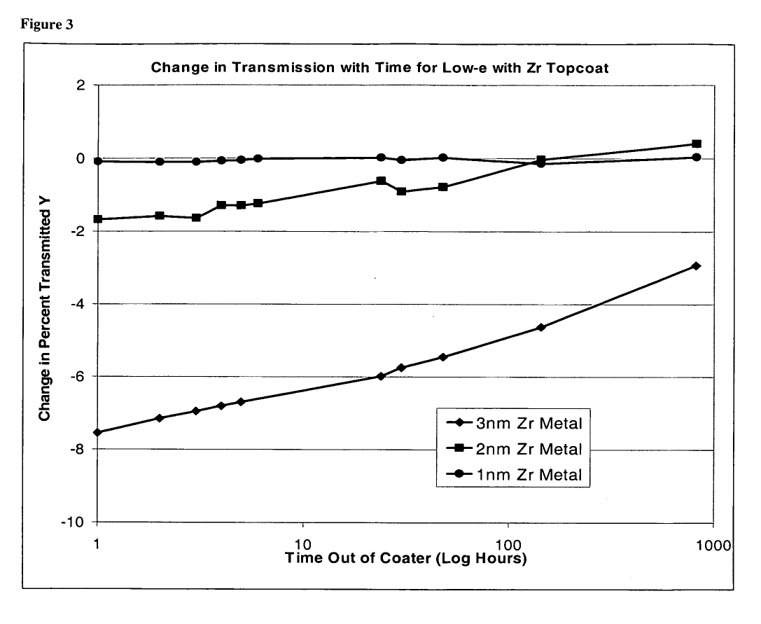

### DETAILED DESCRIPTION OF THE INVENTION

The present invention provides an air oxidizable, scratch resistant protective coating as an outer layer on an optical coating. The outermost layer on the optical coating before the protective coating is applied, preferably comprises silicon nitride, metals, MgF₂ ,TiO2, SiO₂, Al₂O₃, YO, and/or SnZnOx.

The invention consists of a metal, metal alloy, metal compound, or intermetallic layer formed on the air contacting surface of the optical stack to a thickness not greater than that which will fully oxidize in air at room temperature. The thickness of the metal, metal alloys, metal compound or intermetallic layer is such that full oxidation of the metal occurs within several days after removal from the vacuum system and exposure to air. The protective coating is preferably between 1 to 3 nanometers thick. The scratch protection layer can be 2 to 5 nanometers thick if the layer is exposed to a plasma, electrical discharge or ion beam comprising a reactive gas such as oxygen or nitrogen. Since it is well known in the art that very thin layers of metals and metal oxides may not be continuous (U.S. Pat. No. 4,749,397), a coating which is between 1 to 5 nanometers thick and provides protection from scratching was surprising.

Most metal, metal alloy, metal compound or intermetallic layers will fully oxidize at room temperature air if the metal is 3 nanometers or less in thickness. The preferred thickness when the metal is zirconium is 2 nm. The air oxidized layers of this invention must meet two requirements: they must provide scratch protection and oxidize to a substantially transparent state within a certain time span. The acceptable time span is approximately the time between coating and when the optical coating is assembled into its final application. In the case of low-e coated glass, the oxidation must occur before the coating is sealed within an Insulating Glass unit. The metal, metal alloy, metal compound or intermetallic layer preferably oxidizes to a substantially transparent state within 250 hours, more preferably within 25 hours and optimally within 1 hour. Each metal, metal alloy, metal compound or intermetallic candidate for this invention will have its own maximum thickness which meets the oxidation time span requirement. Optimal thicknesses for other metals, metal compounds and intermetallics can easily be determined using routine experimentation.

Thicker metal, metal alloy, metal compound or intermetallic layers may be used if the oxidation in driven by exposure to an oxygen plasma or oxygen ion beam. For some metals, metal alloys, metal compounds or intermetallics the additional thickness in-vacuo oxidation allows may improve scratch resistance provided by the layer. This may be the case when the outermost dielectric is a soft material other than silicon nitride.

Typical candidates for the oxidizable metal component are Ti, Zr, Al, Cr, Fe, Nb, Mo, Hf, Ta, Si, and W. As discussed above, alloys, compounds, mixtures or intermetallic compounds of these metals are also candidates. Zr is the preferred metal. The metals and metal alloys suitable for oxidizable metal scratch resistant layers typically have oxide heats of formation less than −150 kilo-calories per mole of metal and melting points higher than 1600 degrees centigrade. More preferred metals and metal alloys have oxide heats of formation less than −200 kilo-calories per mole of metal. These metals typically oxidize readily and produce scratch resistant oxides. An exception to this is aluminum with a melting point of 660 degrees centigrade.

Any suitable method or combination of methods may be used to deposit the scratch protection layer and the layers in the optical stack. Such methods include but are not limited to evaporation (thermal or electron beam), vacuum evaporation, chemical vapor deposition, plasma assisted chemical vapor deposition, vacuum deposition and non-reactive metal sputtering. Different layers may be deposited using different techniques. The metal layers of this invention are preferably deposited by vacuum deposition especially metal sputtering in an inert gas atmosphere.

The metal compound protective layer according to the present invention can be deposited unoxidized or in a partially oxidized or nitrided state onto any suitable optical stack to improve the scratch resistance. Preferably, outermost layer of the optical stack comprises silicon nitride, metal, MgF₂, TiO₂, SiO₂, Al₂O₃, YO, and/or SnZnOx. More preferably, the outermost layer comprises silicon nitride or silicon oxy-nitride. Various combinations of layers in an optical stack are also known in the art as shown in U.S. Pat. Nos. 4,995,895 and 4,749,397. The optical stack preferably includes at least one silver layer, at least one barrier layer to protect the silver layer during the sputtering process, and optionally at least one blocker, barrier or sacrificial layer which protects the silver layer from oxidizing during heat treatment. One skilled in the art understands that the layers in the stack can be arranged and changed in order to improve or modify the properties of the stack.

The aforesaid layers in the optical stack make up a solar control coating (e.g., a low-E or low emissivity type coating) which may be provided on glass substrates. The layer stack may be repeated on the substrate one or more times. Other layers above or below the described layers may also be provided. Thus, while the layer system or coating is “on” or “supported by” the substrate (directly or indirectly), other layers may be provided there between. Moreover, certain layers of the coating may be removed in certain embodiments, while others may be added in other embodiments of this invention without departing from the overall spirit of this invention.

The protective coating according to the present invention provides improved hardness and density. There are several advantages to the present invention including but not limited to:

1. Metals all undergo a volume expansion during oxidation. This volume expansion can add compressive stress and additional density to a thin film layer. The scratch reduction effects from this layer are very large in light of the layers small thickness.

2. An oxide layer derived from post oxidation of a metal film is often denser than an oxide layer deposited as an oxide such as occurs during reactive sputtering. In reactive sputtering, the target surface is oxidized or partially oxidized. Some or all of the sputtered atoms are in the form of a metal oxide molecule. When these molecules land on the substrate surface, they typically have less ad atom mobility than a metal atom. The lower mobility contributes to lower packing density within deposited coatings.

3. Most low-e products are designed for maximum visible transmission for a given solar heat gain coefficient. It is desirable for any layer within a low-e stack to have minimal optical absorption. The metal layer of this invention, once its oxidation process is complete, adds little or no absorption.

4. This scratch protection layer typically is 3 nm or less in thickness after oxidation. Due to its small thickness, its optical interference effects are small; therefore this layer does not greatly affect the optical properties of the entire low-e stack.

5. Since this layer undergoes complete oxidation in air, heating of the layer has little chemical or optical effect. For temperable low-e coatings, it is desirable to have low color shift during the tempering process. This layer makes no detectable contribution to tempering color shift.

6. Metal layers are generally far easier to sputter than oxide layers. Glass coating involves the continuous operation of sputtering targets for periods of one to four weeks. Target arcing and debris falling on substrates is a problem when sputtering processes are run this long. Metal sputtering creates far less of these issues than reactive sputtering.

7. Metal sputtering allows deposition with less expensive and complicated equipment. The thin layers of this invention may be deposited with a low power DC planar magnetron while reactive sputtering often requires dual rotatable cathodes driven by AC or pulsed DC power supplies.

As used in the present specification, the language “deposited onto” or “deposited on” means that the substance is directly or indirectly applied above the referenced layer. Other layers may be applied between the substance and the referenced layer.

Coated articles according to different embodiments of this invention may be used in the context of architectural windows (e.g., IG units), automotive windows, or any other suitable application. Coated articles herein may or may not be heat treated in different embodiments of this invention.

Certain terms are prevalently used in the glass coating art, particularly when defining the properties and solar management characteristics of coated glass. Such terms are used herein in accordance with their well known meaning. For example, as used herein:

Intensity of reflected visible wavelength light, i.e. “reflectance” is defined by its percentage and is reported as Rₓ Y or Rₓ (i.e. the RY value refers to photopic reflectance or in the case of TY photopic transmittance), wherein “X” is either “G” for glass side or “F” for film side. “Glass side” (e.g. “G”) means, as viewed from the side of the glass substrate opposite that on which the coating resides, while “film side” (i.e. “F”) means, as viewed from the side of the glass substrate on which the coating resides.

Color characteristics are measured and reported using the CIE LAB 1976 a*, b* coordinates and scale (i.e. the CIE 1976 a*b* diagram, III. CIE-C 2 degree observer), wherein:

L* is (CIE 1976) lightness units

a* is (CIE 1976) red-green units

b* is (CIE 1976) yellow-blue units.

The terms “emissivity” (or emittance) and “transmittance” are well understood in the art and are used herein according to their well known meaning. Thus, for example, the term “transmittance” herein means solar transmittance, which is made up of visible light transmittance (TY of Tᵥᵢₛ), infrared energy transmittance (T_{IR}), and ultraviolet light transmittance (Tᵤᵥ) Total solar energy transmittance (TS or Tₛₒₗₐᵣ) can be characterized as a weighted average of these other values. With respect to these transmittances, visible transmittance may be characterized for architectural purposes by the standard Illuminant C, 2 degree technique; while visible transmittance may be characterized for automotive purposes by the standard III. A 2 degree technique (for these techniques, see for example ASTM E-308-95, incorporated herein by reference). For purposes of emissivity a particular infrared range (i.e. 2,500-40,000 nm) is employed. Various standards for calculating/measuring any and/or all of the above parameters may be found in the aforesaid provisional application upon which priority is claimed herein.

“Haze” is defined as follows. Light diffused in many directions causes a loss in contrast. The term “haze” is defined herein in accordance with ASTM D 1003 which defines haze as that percentage of light which in passing through deviates from the incident beam greater than 2.5 degrees on the average. “Haze” may be measured herein by a Byk Gardner haze meter (all haze values herein are measured by such a haze meter and are given as a percentage of light scattered).

“Emissivity” (or emittance) (E) is a measure, or characteristic of both absorption and reflectance of light at given wavelengths. It is usually represented by the formula: E=1-Reflectance_{film}.

For architectural purposes, emissivity values become quite important in the so-called “mid-range”, sometimes also called the “far range” of the infrared spectrum, i.e. about 2,500-40,000 nm., for example, as specified by the WINDOW 4.1 program, LBL-35298 (1994) by Lawrence Berkeley Laboratories, as referenced below. The term “emissivity” as used herein, is thus used to refer to emissivity values measured in this infrared range as specified by ASTM Standard E 1585-93 entitled “Standard Test Method for Measuring and Calculating Emittance of Architectural Flat Glass Products Using Radiometric Measurements”. This Standard, and its provisions, are incorporated herein by reference. In this Standard, emissivity is reported as hemispherical emissivity (Eₕ) and normal emissivity (Eₙ).

The actual accumulation of data for measurement of such emissivity values is conventional and may be done by using, for example, a Beckman Model 4260 spectrophotometer with “VW” attachment (Beckman Scientific Inst. Corp.). This spectrophotometer measures reflectance versus wavelength, and from this, emissivity is calculated using the aforesaid ASTM Standard 1585-93.

“Mechanical durabilility” as used herein is defined by the following test. An abrasive pad is slid back and forth over the coated surface of a flat substrate. A 3M Scotch Brite pad #7448 can be used for this test. The type 7448 pad uses “ultra fine grade” silicon carbide as the abrasive. The pad size is 2″ by 4″. An Erichsen brush tester can be used as the mechanism to move the abrasive back and forth over the sample. The pad holder can be Erichsen part number 0513.01.32 which loads the pad with a weight of 135 grams. A new abrasive pad is used for each test. Test duration was 200 strokes. Damage caused by scratching can be measured in three ways: variation of emissivity, Δhaze and ΔE for film side reflectance. This test can be combined with the immersion test or heat treatment to make the scratches more visible. Good results can be produced using 200 dry strokes with a 135 g load on the sample. The number of strokes could be decreased or a less aggressive abrasive could be used if necessary. This is one of the advantages of this test, depending on the level of discrimination needed between the samples, the load and/or the number of strokes can be adjusted. A more aggressive test could be run for better ranking. The repeatability of the test can be checked by running multiple samples of the same film over a specified period.

The terms “heat treatment”, “heat treated” and “heat treating” as used herein mean heating the article to a temperature sufficient to enabling thermal tempering, bending, or heat strengthening of the glass inclusive article. This definition includes, for example, heating a coated article to a temperature of at least about 1100 degrees F. (e.g., to a temperature of from about 550 degrees C. to 700 degrees C.) for a sufficient period to enable tempering, heat strengthening, or bending.

Glossary

Unless otherwise indicated the terms listed below are intended to have the following meanings in this specification.
Ag silver
TiO₂ titanium dioxide
NiCrOₓ an alloy or mixture containing nickel oxide and chromium oxide. Oxidation states may vary from stoichiometric to substoichiometric.
NiCr an alloy or mixture containing nickel and chromium
SiAlNₓ reactively sputtered silicon aluminum nitride which may include silicon oxy-nitride. Sputtering target is typically 10 weight % Al balance Si although the ratio may vary.
SiAlOₓNₓ reactively sputtered silicon aluminum oxy-nitride
Zr zirconium
deposited on applied directly or indirectly on top of a previously applied layer, if applied indirectly, one or more layers may intervene
optical coating one or more coatings applied to a substrate which together affect the optical properties of the substrate
low e-stack transparent substrate with a low heat emissivity optical coating consisting of one or more layers
barrier layer deposited to protect another layer during processing, may provide better adhesion of upper layers, may or may not be present after processing
layer a thickness of material having a function and chemical composition bounded on each side by an interface with another thickness of material having a different function and/or chemical composition, deposited layers may or may not be present after processing due to reactions during processing
co-sputtering Simultaneous sputtering onto a substrate from two or more separate sputtering targets of two or more different materials. The resulting deposited coating may consist of a reaction product of the different materials, an un-reacted mixture of the two target materials or both.
Intermetallic A certain phase in an alloy system composed of specific stoichiometric proportions of two or more metallic elements. The metal elements are electron or interstitial bonded rather existing in a solid solution typical of standard alloys. Intermetallics often have distinctly different properties from the elemental constituents particularly increased hardness or brittleness. The increased hardness contributes to their superior scratch resistance over most standard metals or metal alloys.
substantially transparent An optical absorption in the visible wavelengths of not greater than about 2%, preferably not greater than 1%.

### EXAMPLES

The following examples are intended to illustrate but not limit the present invention.

### Example 1

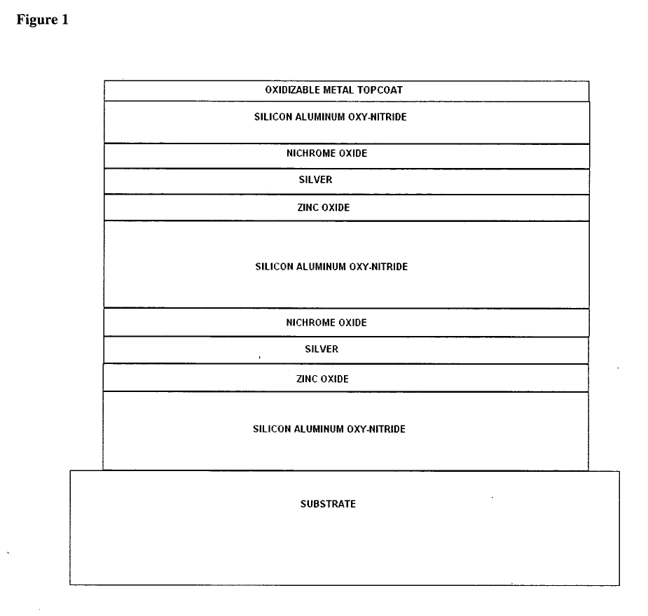

A low-e structure shown in FIG. 1 is sputtered with an outermost dielectric of silicon nitride. As a last coating step in the vacuum coater, a layer of 2 nm of Zr is deposited on the silicon nitride. The Zr layer oxidizes in air over a period of one week and the transmission of the low-e structure reaches a level within 0.5% of the same non-topcoated low-e.

### Example 2

A low-e structure shown in FIG. 1 is sputtered with an outermost dielectric of silicon nitride. As a last coating step in the vacuum coater, a layer of 2.5 nm of Zr is deposited on the silicon nitride. A further oxidation step is carried out in the vacuum coater where the Zr layer is exposed to an oxygen containing plasma. The Zr layer further oxidizes in air over a period of one week and the transmission of the low-e structure reaches a level within 0.5% of the same non-topcoated low-e.

Experimental Procedure:

Coating setup—Samples were sputter coated using a 1 meter wide Twin-Mag target with Zr targets. Power was AC supplied by a Huttinger BIG 100.

Samples were sputtered under three different atmospheres:
1. Argon only to deposit a metal layer.
2. Addition of small amount (10 sccm) O₂ to create oxygen doped Zr. The layer was still substantially metallic. Material is signified in the data as ZrOx.
3. Addition of small amount (10 sccm) N₂ to create nitrogen doped Zr. The layer was still substantially metallic. Material is signified in the data as ZrNx.

Substrates—A low-e stack according to FIG. 1 was used as the substrate for the Zr. The outermost dielectric of this low-e is silicon oxy-nitride. The Zr was also deposited on low-e coatings not having silicon nitride as the outermost layer.

Topcoat Layers—Layers were 1, 2, 3 nm thick layers of Zr.

Oxidation—Two methods of oxidation were used:
1. Exposure to ambient air at room temperature

2. In-vacuo exposure to an oxygen ion beam or plasma. This exposure was carried out using a Veeco 34 centimeter linear anode layer ion source. The source was operated in either high current (diffuse) or high voltage (collimated) modes. Operating conditions are shown in the table below.

| | | | | | Chamber |
|---|---|---|---|---|---|
| | | | | | pressure |
| | Ar sccm | O2 sccm | Kilovolts | amps | (mbar × 10⁻3) |
| Collimated | 10 | 25 | 2.9 | 0.5 | 4.46 |
| Diffuse | 10 | 45 | 0.5 | 1.3 | 17.5 |

Scratch Testing—Scratch testing was done using a Scotch Brite Scratch test. Samples were scratched immediately after completion of coating and again after 24 hours. This was to determine scratch protection with the least amount of oxidation and after oxidation was assumed to be approximately complete.

Scotch Brite Scratch Test Description:

To test scratch resistance of a thin film coated surface, an abrasive pad was slid back and forth over the coated surface of a flat substrate. 3M Scotch Brite pad #7448 was used for this test. The type 7448 pad used “ultra fine grade” silicon carbide as the abrasive. The pad size was 2″ by 4″. The Erichsen brush tester was used as the mechanism to move the abrasive back and forth over the sample. The pad holder was Erichsen part number 0513.01.32 which loads the pad with a weight of 135 grams. A new abrasive pad was used for each test. Test duration was 200 strokes.

Damage caused from scratching was measured in two ways: delta haze, and delta E for film side reflectance. Delta haze was measured by subtracting the haze of the scratched film from the haze of the pre-scratched film. Delta E (color change) measurements were made by measuring the film side reflection (Rf) of the undamaged and scratched films. The delta or difference in color coordinates before and after scratch, L*, a*, and b*, were put into this formula to calculate Delta E caused by the scratch:
Delta E=(delta L*²+delta a*²+delta b*²)^{1/2} Eqn. 1
Samples were measured for delta haze and delta E both before and after tempering. Tempering amplifies scratch size and appearance making the degree of scratching more obvious and measurable.

Optical Measurements—TY, Tcolor, RfY, Rf color, RgY and Rg color was measured at approximately 1 hour intervals to track optically the oxidation progress of air oxidation samples.

Intensity of reflected visible wavelength light, i.e. “reflectance” is defined by its percentage and is reported as Rₓ Y or Rₓ (i.e. the RY value refers to photopic reflectance or in the case of TY photopic transmittance), wherein “X” is either “g” for glass side or “f” for film side. “Glass side” (e.g. “g”) means, as viewed from the side of the glass substrate opposite that on which the coating resides, while “film side” (i.e. “f”) means, as viewed from the side of the glass substrate on which the coating resides.

Scratch Testing Results:

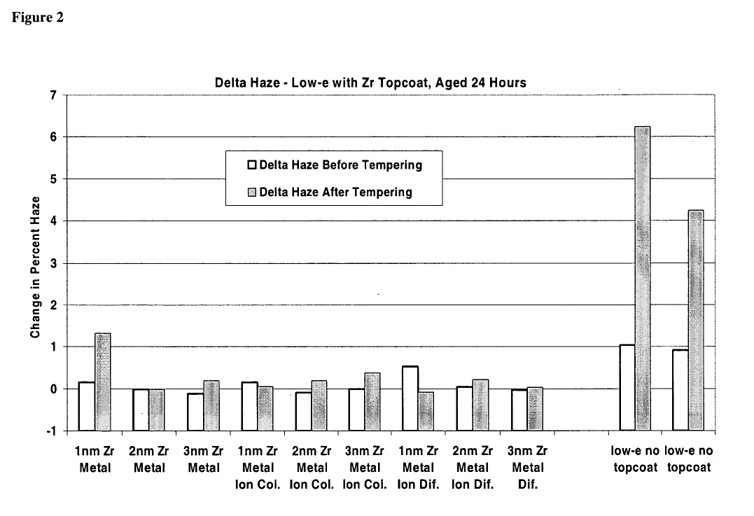

Scratch—All samples showed significantly improved scratch resistance with the Zr topcoat regardless of coating age. After aging 24 hours, however, the most improvement in scratch resistance occurred. It is believed that most of the zirconium metal layer has to undergo oxidation before the full potential for scratch protection is achieved. Delta haze results for all samples are shown in FIG. 2.

Optical Results—Different thicknesses of metal topcoat showed different degrees of progress towards complete oxidation (FIG. 4). The one nanometer thick layers easily reached transmission levels similar to the original uncoated low-e values. These values for the substrates of this experiment were about 75.6%. One nanometer samples tended to show less scratch protection than thicker Zr layers.

Two nanometer Zr samples were about 0.5% below the original transmission after 120 hours. They would be expected to be able to reach an acceptable level of oxidation and therefore meet transmission requirements. In vacuo oxidation allowed this layer to easily reach transmission requirements.

Three nanometer air oxidation samples appear to be unable to reach transmission requirements within the acceptable time limits. The in vacuo oxidization of 3 nm Zr raised the transmission about 3 percentage points but was not sufficient to allow this layer to meet requirements.

### Example 3

Scratch data for low-e stacks with and without topcoats is presented in the table below. The ZrSi topcoat in this case is a co-sputtered layer done on a Twin-Mag where one side of the magnetron is setup with a Zr target and the other side is setup with a Si10wt % Al target. The sputtering of the topcoat is done in an argon atmosphere. Sputtering power was equal on both targets. The resulting topcoats were about 3 nm thick.

The scratch test was the 200 stroke Scotch-Brite mechanical durability test. In this case the scratch damage on all samples was too low to detect by haze measurements. The quantification was done by a direct count of scratches on the coated surface.

The counts were carried out by counting all visible scratches across the path of the Scotch-Brite pad path. Counts were taken in three places; one in the center and 1.5 inches to either side of center of the scratched sample. The scratched samples were 4″×6″. The Zr and ZrSi topcoats both provided scratch protection in this test.

| | |
|---|---|
| Topcoat | Scratch Counts |

| Type | left side | center | right side | average |
|---|---|---|---|---|
| none | 25 | 7 | 16 | 16 |
| none | 27 | 17 | 19 | 21 |
| Zr | 8 | 7 | 10 | 8.3 |
| ZrSi | 6 | 17 | 11 | 11.3 |

1. An article with improved scratch protection, comprising
a substrate,
an optical coating comprising one or more layers on the substrate, and
an outermost scratch protection layer comprising a protective metal, metal alloy, metal compound or intermetallic coating, wherein said outermost scratch protection layer is 1 to 3 nm thick.

2. The article according to claim 1, wherein said metal is fully oxidized.

3. The article according to claim 1, wherein the metal portion of said metal alloy or metal compound is selected from the group consisting of chromium, iron, titanium, zirconium, hafnium, niobium, tantalum, molybdenum, tungsten, iron, aluminum and silicon.

4. The article according to claim 3, wherein said metal portion is zirconium.

5. The article according to claim 1, wherein the metal is zirconium.

6. The article according to claim 1, wherein said substrate is a transparent substrate.

7. The article according to claim 6, wherein said transparent substrate is glass with optical coatings deposited on it.

8. The article according to claim 7, wherein said optical coatings comprise one or more layers of NiCrOₓ, Ag, and SiAlNₓ.

9. The article according to claim 8, wherein the metal is zirconium.

10. The article according to claim 1, wherein the outermost scratch protection layer does not change the spectral reflectance and/or transmission in the visible or infrared wavelengths of the article.

11. The article according to claim 1, wherein the outermost scratch protection layer is deposited onto a layer of SiAlOxNy.

12. An article with improved scratch protection, comprising
a substrate,
an optical coating comprising one or more layers on the substrate, and
an outermost scratch protection layer comprising a protective metal, wherein said outermost scratch protection layer is 2 to 5 nm thick.

13. A method for improving the scratch protection of optical coatings on an article, comprising
depositing an optical coating comprising one or more layers on an article,
depositing a 1-3 nm layer comprising an unoxidized metal, metal alloy, metal compound or intermetallic on said optical coating to provide a scratch protection layer, and
oxidizing said metal, metal alloy, metal compound or intermetallic layer.

14. The method according to claim 13, wherein the metal portion of said metal alloy or metal compound is selected from the group consisting of chromium, iron, titanium, zirconium, hafnium, niobium, tantalum, molybdenum, tungsten, iron, nickel, aluminum and silicon.

15. The method according to claim 14, wherein said metal portion is zirconium.

16. The method according to claim 13, wherein said substrate is a transparent article.

17. The method according to claim 13, wherein said substrate is glass.

18. The method according to claim 13, wherein said optical coating includes one or more layers of NiCrOₓ, Ag, and SiAlNₓ.

19. The method according to claim 13, wherein said metal, metal alloy, metal compound or intermetallic layer is oxidized by exposure to air.

20. The method according to claim 13, wherein said scratch protection layer is deposited onto a layer of SiAlOxNy.

21. The method according to claim 13, wherein said metal has an oxide heat of formation less than −150 kCal/mole and a melting point of greater than 1600 degrees centigrade.

22. The method according to claim 21, wherein said metal has a heat of formation less than −200 kCal/mole and a melting point greater than 1600 degrees centigrade.

23. The method according to claim 13, wherein said metal oxidizes in ambient air to a substantially transparent state within 250 hours after the metal is deposited.

24. The method according to claim 23, wherein said metal oxidizes to a substantially transparent state within 25 hours after the metal is deposited.

25. The method according to claim 24, wherein said metal oxidizes to a substantially transparent state within 1 hour after the metal is deposited.

26. A method for improving scratch protection of an article with an optical coating, comprising
depositing an optical coating comprising one or more layers on an article,
depositing a 2-5 nm layer comprising an unoxidized metal, metal alloy, metal compound or intermetallic layer on said optical coating to provide a scratch protection layer, and
oxidizing said metal, metal alloy, metal compound or intermetallic layer by exposure to a plasma, electrical discharge or ion beam comprising a reactive gas.

27. The method according to claim 26, wherein said reactive gas is oxygen or nitrogen.
